(19) United States
(12) Patent Application Publication
(10) Pub. No.: US 2005/0251537 A1
(43) Pub. Date: Nov. 10, 2005

(54) File locking

(75) Inventors: Keith Schwols, Fort Collins, CO (US); George Harold Robbert, Ft. Collins, CO (US); Robert William Proulx, Fort Collins, CO (US)

Correspondence Address: SCHWEGMAN, LUNDBERG, WOESSNER & KLUTH, P.A., P.O. BOX 2938, MINNEAPOLIS, MN, 55402-0938, US

(73) Assignee: Hewlett-Packard Development Company, L.P.

(21) Appl. No.: 10/839,683

(22) Filed: May 5, 2004

(51) Int. Cl. G06F 7/00

(52) U.S. Cl. 707/200

(57) ABSTRACT

An information file is inspected for an identity of a locking service associated with a desired file. The locking service is contacted, and the locking service grants access if the desired file is available.

### BACKGROUND

File locking techniques are used in distributed network environments where a single file or resource can be shared among a plurality of network users or resources. Proper lock management ensures the integrity of operations (e.g., reads and writes) against distributed files and permits proper and accurate availability of those files. Conventionally, two techniques have been used for managing file locking in distributed environments.

### BRIEF DESCRIPTION OF THE DRAWINGS

FIG. 1 is a flowchart of a method for managing distributed file locks, according to an embodiment.

FIG. 2 is a flowchart of another method for managing distributed file locks, according to an embodiment.

FIG. 3 is a diagram a file locking system, according to an embodiment.

FIG. 4 is a flowchart associated with the processing of a locking service, according to an embodiment.

### DETAILED DESCRIPTION

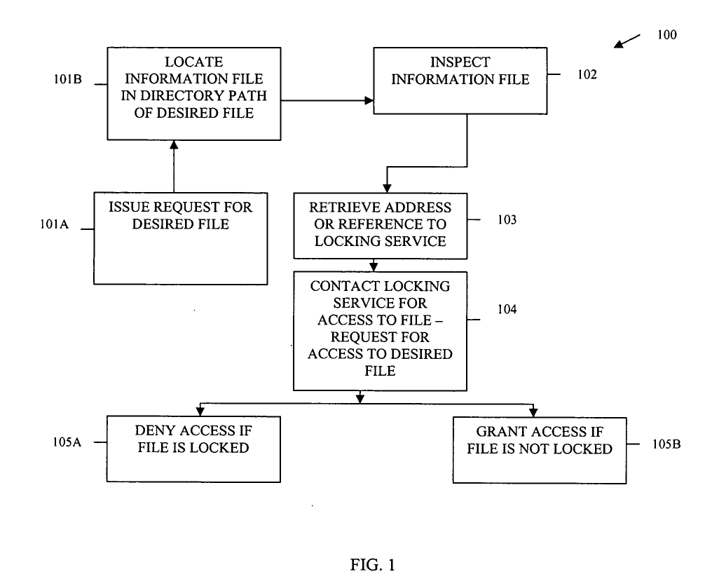

FIG. 1 is a flowchart for one method 100 to manage distributed file locks. The method 100 is implemented in a machine-readable or accessible medium. In one embodiment, the method 100 (hereinafter “processing”) represents selective processing instructions used by custom-developed applications which desire access to a data file. One way to achieve this is to provide a set of Application Programming Interface (API) commands which can be linked and used by custom-developed applications. The API includes commands for operations that test (for access availability) and set (reserve for exclusive access) against files in a directory.

Initially, an appliance, storage device, or processing device is interfaced to a network where a variety of other processing devices can access, for purposes of acquiring or modifying, data files that reside on the appliance, storage device or processing device. The data files reside on a first device and the file system or structure of those data files may not be known in advance by the processing; however, standard network protocols and other standard communication applications, such as Network File System (NFS) permit the processing to access and modify a number of the data files on the first device.

Moreover, the first device includes one or more information files. Information files are files that include the identity (e.g., address, link, pointer, or reference information) of a specific locking service. That specific locking service manages lock/semaphore information for one or more data files that reside on the first device; however, in many instances the locking service resides on a different device than the first device. The information files are located within the same directory or the same directory path of the data files. That is, a specific directory may not have an information file, but an information file exists within the directory path of that specific directory.

For example, consider the following directory “/hp/enterprise/information/patents/KeithSchwols,” this directory includes a specific data file called “keithsfirstpatent” which a user application wants to access. The directory may not include an information file (although it can in some other embodiments), but the user application can locate an information file somewhere in the directory path of the directory (e.g., somewhere in a parent directory of the directory). Thus, the user application may locate an information file entitled “lockservice” in the parent directory “/hp/enterprise/information/patents.” The lockservice file includes a reference to a specific locking service that is managing lock information for keithsfirstpatent data file, which the user application contacts using API commands to request access to that data file. That access request may be to do something nonvolatile (read) or to do something volatile (write) to the data file.

Initially, at 101A, a requesting application attempts to access (via a set or test operation) a desired file. In response to this request for access, at 101B, the processing locates an information file within a directory path of the first device that houses a desired file. The information file may reside within the directory of the desired file or may reside in a parent directory somewhere along the directory path of the data file's directory. Thus, locating the information file associated with a desired data file is initiated when a requesting application requests some access (volatile (write or set) or nonvolatile (read or test)) to the desired data file.

Next, at 102, the information file is inspected for purposes of acquiring an address, a link, a reference, or a pointer, at 103, for a specific locking service. This information is activated to contact the appropriate locking service at 104. The contact includes an access request (desired operation of the requesting application) and the identity of the desired file. In an embodiment, this is the information that the locking service uses to make a determination as to whether the requesting application can be denied access at 105A or granted access at 105B.

The locking service can be any custom-developed service. The locking service manages file locking for a plurality of files that reside on the first device. In some embodiments, the locking service resides on the first device, although in other embodiments the locking service does not reside on the first device. Moreover, multiple instances of the locking service can be processing on a plurality of different devices, where each locking service manages lock information for different files on the first device. Additionally, in some embodiments, multiple instances of a locking service can be designed to cooperate with one another and manage lock information for the same files on the first device.

The processing presents a variety of benefits over conventional techniques. First, the locking service or any interface portion of the locking service does not have to process on the first device, which houses the desired data file. Thus, the filing locking is decoupled from the storage device or network resource. In this way, a file-based locking technique is achieved in a decoupled fashion and is easily integrated and used with a variety of proprietary storage devices or network resources; because an information file references an external locking service on a different device. Moreover, with this approach, the processing logic of a locking service does not have to be complied and linked on the first device; rather, the information files are data files which can be easily placed within the proper locations of the first device as data.

Second, the processing utilizes the benefits of a file-based approach by having a locally stored information file. However, with the techniques of the processing a single information file services data files in an entire directory or in an entire directory path or sub-directory path. Thus, the additional storage used and the additional files created on the first device are nominal and will not impact the performance or trigger hard or soft total file limits on the first device.

Third, the information files permit locking services to be dynamically interchanged or modified if desired. That is, if a particular locking service or the device on which it is processing becomes too heavily loaded, then some of the files in which that particular locking service is managing can be segmented into subgroups and delegated to other locking services for management. Additionally, locking services can be moved around to different devices or servers as desired. All of this is achieved by updating the affected information files in order to reflect any changed locking service. Moreover, this can be achieved dynamically and without significant interruption to the requesting applications that are consuming desired data files.

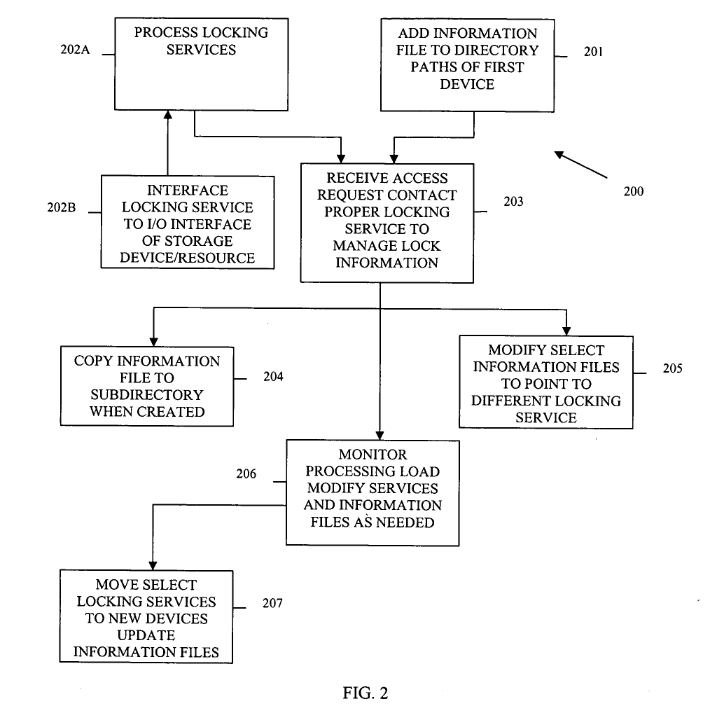

FIG. 2 is another method 200 for managing distributed file locks. Again, the method 200 is implemented in a machine-readable or accessible medium. The method 200 represents a processing environment used by method 100 of FIG. 1 above. That is, method 200 provides the initial environment used by method 100 of FIG. 1 to manage distributed file locks. The method 200 represents one or more applications or services that cooperate to provide a processing environment and to perform distributed file locking within that processing environment.

At 201, information files are added or populated to a first device that houses desired data files. These information files include references, links, addresses, or pointers to one or more locking services. A single information file services a plurality of data files that reside on the first device. Each information file can be placed within the same directories of desired data files or within parent directories within the same directory paths of the desired data files. Some specific directories may not include an information file, but one of their parent directories will include an information file. Alternatively, some specific directories will include an information file. The arrangement of the information files within the first device is configurable based on the usage patterns and processing load of the first device and the desired data files. Additionally, the arrangement and content of the information files can be dynamically altered based on changing environments or architectural configurations of a network that implements the method 200.

Concurrent to, prior to, or subsequent to the adding of the information files to the first device, one or more locking services are initiated and processed at 202A. In some embodiments, at 202B, this entails also configuring and interfacing the locking services to an Input/Output (I/O) interface of a storage device or resource that houses the information files and desired data files. The locking services process on one or more different devices from the first device that houses the desired data files and the information files. The locking services are assigned groups of data files for which they manage access locks. The identity of any particular locking service will be included within one or more information files that reside in the first device. The locking services remotely manage lock/semaphore information for the desired data files. Management is remote because the locking services are processing on different devices from that of the first device which houses the desired data files.

Once the proper environment is established by 201 and 202A (optionally 202B), the method 200 is in a position to manage distributed file locks for the desired data files which reside of on the first device. Accordingly, at some point after initialization an application will make a request to access one of the data files on the first device. That application will use an API similar to the one described with respect to method 100 of FIG. 1 to issue an access operation (test or set) against a specifically desired data file. That access operation triggers processing described above with respect to method 100 in order to locate an information file in the directory path of the desired data file and to contact the proper locking service with the command and the identity of the desired data file. At 203, this information is received as an access request by the appropriate locking service and the operation is permitted, delayed, or denied based on the present locking information associated with the desired data file.

During operation, a variety of other situations may exist that may necessitate moving or copying locking services to new devices in order to ensure an optimal processing environment for the requesting applications, the first devices, the different devices and their corresponding locking services. Thus, in order to avoid the processing associated with locating an information file from a parent directory of a child directory that houses desired data files, information files can be copied, at 204, directly into subdirectories as they are created on the first device. This may be especially useful when the depth of the directory paths on the first device begin to get deeper (e.g., the directory paths become longer).

Another situation may occur, when a locking service is moved to a new device. This can occur for a variety of reasons, such as the device processing a specific locking service fails, is brought down for maintenance, is upgraded, or is switched out for a different device. When this occurs, at 205, the affected information files resided on the first device are updated to reflect the new location for the changed locking service.

Also, it may be desirable to have one or more load balancing applications that monitor, at 206, the processing loads associated with specific devices and specific locking services. When a processing load reaches an unacceptable level identified by exceeding a predefined and configurable threshold, additional locking services can be instantiated and processed, some locking services can be moved, at 207, or some locking services can be copied to new devices. Again, when a specific locking service is changed with respect to the files that it manages or relocated to a different location, the affected information files on the first device are dynamically updated to reflect the changed location.

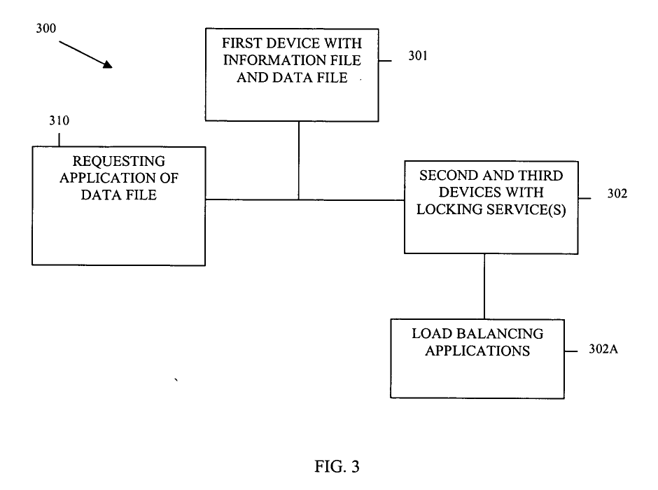

FIG. 3 is a distributed file locking system 300. The distributed file locking system 300 is implemented in a machine-readable and accessible medium and is accessible over a network or combination of networks. The networks can be hardwired, wireless, infrared, or a combination of hardwired, wireless, and/or infrared. The distributed file locking system 300 implements the techniques presented above with respect to method 100 and method 200 of FIGS. 1 and 2, respectively.

The distributed file locking system 300 minimally includes a first device 301 and a second device 302. The first device 301 includes an information file and a desired data file. The desired data file is a file or resource that a requesting application 310 wants to access in some manner. The access can be volatile (write operation) or nonvolatile (read operation). The information file resides in the same directory or same directory path (e.g. within a parent directory) as the desired data file within the first device 301.

The information file references the locking service which resides on the second device 302, that locking service manages lock information and access to the desired data file which resides on the first device 301.

The first device 301 can be a network appliance, a storage appliance or device, or another network resource. The second device 302 is a processing device, such as a server that communicates with the first device 301 via a network connection using standard network protocols and interface operations associated with and published by the first device 301.

During operation of the distributed file locking system 300, the requesting application 310 uses an API similar to method 100 of FIG. 1 to make its access request (test or set) for a specific data file that resides on the first device 301. This triggers the processing described with method 100 and method 200 of FIGS. 1 and 2, respectively, in which an information file is located within the directory path of the data file on the first device 301 and a locking service residing on the second device 302 is contacted. The locking service then determines based on the type of operation being requested by the requesting application 310 and the identity of the desired data file whether the request can be granted or should be denied or delayed for some configurable period of time until conditions change. The locking service communicates the results to the requesting application.

In some embodiments, load balancing applications 302A can be integrated and processed within the distributed file locking system 300. The load balancing applications 302A monitor the processing loads of the devices 302 which process the locking services and the processing loads of the locking services themselves. If configurable conditions are detected that warrant initiating a new locking service on a new device, then this can be achieved by the load balancing applications 302A or other assisting applications interfaced to the load balancing applications 302A.

Thus, a new locking service can be instantiated and processed on a third device 302 and that new locking service can be delegated with locking management responsibilities for the desired data file and/or for other data files on the first device 301. When this occurs, the proper information file is updated on the first device 301 to reflect the new locking service on the third device 302. Alternatively, the existing locking service can be moved or copied to a third device 302, and again when this occurs the information file on the first device 301 is updated to reflect the new location of the existing locking service on the third device 302.

In manners similar to what was discussed above with respect to FIGS. 1 and 2, the distributed file locking system 300 is also capable of copying information files directly into subdirectories or children directories of data files residing on the first device 301. When the directories become too deep or when too many files are assigned to the same locking service and it becomes more efficient to specifically copy the information files directly to the directories in which the data files reside.

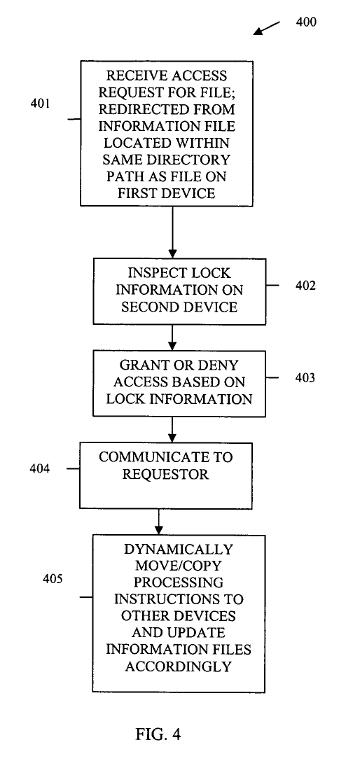

FIG. 4 is another method 400 for managing distributed file locks. The method 400 (herein after “locking service”) is implemented on a machine readable medium as a plurality of executable instructions. That medium can be a removable medium or a fixed medium interfaced to a processing device. The medium when interfaced with a processing device performs operations associated with a locking service. The locking service remotely manages file lock information for data files that reside on different processing devices, storage devices, or appliances.

Initially, a requesting application uses an API similar to what was described above with respect to method 100 of FIG. 1 in order to make access requests (test and set) for desired files that reside on a first device. Those requests trigger operations that locate an information file for the desired data file. That information file identifies the locking service represented by the processing of method 400 and FIG. 4.

Accordingly, at 401, the locking service receives the access request via redirection from the requesting application. In other words, the information file located by the API commands, which are triggered by the requesting application's initial access request, redirects the access request to the locking service. The information file is in the same directory or same directory path as the desired data file.

At 402, the locking service inspects lock/semaphore information associated with the desired data file. Moreover, the locking service processes on a second device which is different from the first device that houses the desired data file and the information file. The access request includes the identity of the requesting application, the identity of the desired data file on the first device, and the specific access operation that the requesting application wants to perform against the desired data file. This information permits the locking service to inspect its policies, files, or other data to make a determination at 403 whether to grant, deny, or temporarily delay access to the desired data file. Once a determination is made, the determination is communicated to the original requesting application at 404.

In some embodiments, at 405, the instructions associated with the locking service can be moved or copied to other devices. When this occurs, other applications or processes, such as the ones discussed above with methods 100, 200, and 300 of FIGS. 1-3, respectively, will update the appropriate or affected information files residing on the first device to reflect this new assignment to a new copy or moved instance of the locking service instructions.

Each processing instance of the locking service is associated with managing one or more data files that reside on the first device. The number of processing instances and locations of these processing instances can be dynamically configured, instantiated, loaded, and processed based the particular network environment or based on dynamically determined processing loads.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) to allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Thus the following claims are hereby incorporated into the Description of the Embodiments, with each claim standing on its own as a separate exemplary embodiment.

1. A method comprising:
inspecting an information file that is associated with a request to access a desired file;
contacting a locking service identified in the information file; and
granting access, by the locking service, to the desired file if the desired file is available.

2. The method of claim 1 wherein inspecting further includes locating the information file within a parent directory path of the desired file.

3. The method of claim 1 wherein inspecting further includes retrieving an address or a reference from the information file, wherein the address or the reference resolves a location of the locking service.

4. The method of claim 1 further comprising initially issuing the request for the desired file, wherein the desired file resides on at least one of a storage appliance, a network resource, and a network processing device.

5. The method of claim 1 wherein contacting further includes requesting access to the desired file from the locking service wherein the locking service resides on a remote processing device from a storage device that houses the desired file and the information file.

6. The method of claim 1 wherein the method is processed on a device that houses the desired file and the information file.

7. The method of claim 1 wherein the method is processed on a separate device from a device that houses the desired file and the information file, and wherein the separate device acts as a locking service for the desired file.

8. A method comprising:
adding information files to directories having files, wherein each directory path includes one or more of the information files and one or more of the files, and wherein the information files identify one or more locking services, wherein each of the locking services reside on one or more different devices from that of the files and the information files; and
processing the locking services to remotely manage locks for the files from the one or more different devices.

9. The method of claim 8 further comprising, copying one of the information files from a parent directory to a child directory when a child directory is created within the parent directory.

10. The method of claim 8 further comprising, modifying select ones of the information files to point to different locking services.

11. The method of claim 10 further comprising monitoring a processing load of the locking services and the different devices to determine which of the locking services should be changed within the select ones of the information files.

12. The method of claim 8 further comprising, interfacing the locking services to an interface associated with a storage device that houses the files and the information files.

13. The method of claim 8 further comprising:
moving a select one of the locking service to a new device along; and
updating affected information files with a new location for the moved locking service.

14. A system, comprising:
an information file residing on a first device; and
a locking service residing on a second device, wherein the information file is located in a same directory path as a data file, and wherein the information file identifies the locking service on the second device and the locking service manages access locks for the data file.

15. The system of claim 14, wherein the first device is at least one of a storage appliance and a processing device.

16. The system of claim 14, wherein the second device is a server which communicates with the first device via a network connection.

17. The system of claim 14 further comprising an application that requests access to the data file located on the first device and wherein the access request is handled by the locking service identified in the information file.

18. The system of claim 14, wherein the locking service is moved to a third device and the information file is updated on the first device to reference a new location of the locking service on the third device.

19. The system of claim 14, wherein the information file is copied to a subdirectory of the same directory path when the subdirectory is created on the first device.

20. The system of claim 14 further comprising a load balancing application that monitors a processing load of the locking service and the second device and changes the information file to reference a new locking service located on a third device if the processing load exceeds a predefined threshold.

21. A computer readable medium having locking service instructions stored thereon for managing file locks, the instructions when accessed performing the method comprising:
receiving an access request for a file located on a first device, wherein the access request was redirected from the first device via an information file located in a same directory path as the file on the first device; and
inspecting lock information associated with the file to determine if the file is available to satisfy the access request.

22. The medium of claim 21 further including instructions for communicating to a requestor permission to access the file if the file is available.

23. The medium of claim 21, wherein the instructions are loaded and processed on a different device from the first device, and wherein the instructions communicate with other interface instructions associated with the first device.

24. The medium of claim 21, wherein the instructions are moved from a second device to a third device and wherein the information file is updated on the first device to reference the instructions on the third device.

25. The medium of claim 21, wherein the instructions are copied from a second device to a third device based on a dynamically determined processing load of the second device or the instructions, and wherein the information file is updated on the first device to reference the copied instructions on the third device of a number of selective directories on the first device.
